(19) United States
(12) Patent Application Publication
(10) Pub. No.: US 2023/0028284 A1
(43) Pub. Date: Jan. 26, 2023

(54) MANUFACTURING METHOD OF ELECTRODE SLURRY, MANUFACTURING METHOD OF ELECTRODE, MANUFACTURING METHOD OF POSITIVE ELECTRODE, ELECTRODE FOR SECONDARY BATTERY, AND POSITIVE ELECTRODE FOR SECONDARY BATTERY

(71) Applicant: SEMICONDUCTOR ENERGY LABORATORY CO., LTD., ATSUGI-SHI, KANAGAWA-KEN (JP)

(72) Inventors: Teruaki OCHIAI, Atsugi, Kanagawa (JP); Yumiko YONEDA, Isehara, Kanagawa (JP); Kazuhei NARITA, Ota, Tokyo (JP); Kazutaka KURIKI, Ebina, Kanagawa (JP)

(21) Appl. No.: 17/788,369

(22) PCT Filed: Dec. 21, 2020
(86) PCT No.: PCT/IB2020/062267

§ 371 Date: Jun. 23, 2022

(30) Foreign Application Priority Data
Dec. 27, 2019 (JP) 2019-238615

(51) Int. Cl. H01M 4/04; H01M 4/62

(52) U.S. Cl. CPC H01M 4/0471; H01M 4/0404; H01M 4/625

(57) ABSTRACT

A method for manufacturing a novel electrode is provided. The method includes the steps of applying, to a current collector, a mixture comprising an active material, a conductive additive comprising a graphene compound, a binder, and a dispersion medium; performing a drying treatment on the mixture; performing a heat treatment on the mixture at a temperature higher than a temperature of the drying treatment; reducing the graphene compound in the mixture by a chemical reaction using a reducing agent; and performing a thermal reduction treatment on the mixture at a temperature higher than the temperature of the heat treatment.

### TECHNICAL FIELD

One embodiment of the present invention relates to an electrode for a secondary battery, a positive electrode for a secondary battery, a secondary battery, and a method for manufacturing the same. In addition, the present invention relates to an object, a process, a machine, manufacture, or a composition (composition of matter). One embodiment of the present invention relates to a semiconductor device, a display device, a light-emitting device, a power storage device, a lighting device, an electronic device, or a manufacturing method thereof.

Note that in this specification, a power storage device refers to every element and device having a function of storing power. For example, a storage battery (also referred to as a secondary battery) such as a lithium-ion secondary battery, a lithium-ion capacitor, an all-solid battery, and an electric double layer capacitor are included.

In addition, electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries and the like, and all-solid batteries have been actively developed. In particular, demands for lithium-ion secondary batteries with high output and high capacity have rapidly grown with the development of the semiconductor industry, for portable information terminals such as mobile phones, smartphones, and laptop computers; portable music players; digital cameras; medical equipment; next-generation clean energy vehicles such as hybrid electric vehicles (HV), electric vehicles (EV), and plug-in hybrid electric vehicles (PHV); and the like. The lithium-ion secondary batteries are essential as rechargeable energy supply sources for the modern information society.

A lithium-ion secondary battery includes at least a positive electrode and a negative electrode that each include an active material into/from which lithium ions can be reversibly inserted and extracted, a separator placed between the positive electrode and the negative electrode, and a non-aqueous electrolyte.

The positive electrode includes a positive electrode active material and a positive electrode current collector and is formed by applying a positive electrode slurry including a conductive additive, a binder, and the positive electrode active material to the positive electrode current collector. Similarly, the negative electrode includes a negative electrode active material and a negative electrode current collector and is formed by applying a negative slurry including a conductive additive, a binder, and the negative electrode active material to the negative electrode current collector.

The conductive additive is added to efficiently form a conductive path from the active material to the current collector. However, when the content of the conductive additive is large in the positive electrode or the negative electrode, the amount of the active material per weight of the electrode is reduced, which decreases the battery capacity. Accordingly, a highly conductive additive which ensures an efficient conductive path with a small amount is desired.

Hence, in Patent Document 1, by mixing a conductive additive such as acetylene black (AB) and graphite (graphite) particles, the electron conductivity between active materials or between an active material and a current collector is improved. Thus, a positive electrode active material with high electron conductivity can be provided.

However, because a general particulate conductive additive such as acetylene black has a large average diameter of several tens of nanometers to several hundreds of nanometers, the contact between acetylene black and an active material hardly becomes surface contact and tends to be point contact. Consequently, contact resistance between the active material and the conductive additive is high. In contrast, when the amount of the conductive additive is increased to increase contact points between the active material and the conductive additive, the ratio of the amount of the active material in the electrode is reduced, resulting in a reduction in the charge and discharge capacity of the battery.

On the other hand, Patent Document 2 discloses the use of a single layer or a stacked layer of graphene (which is referred to as two-dimensional carbon in Patent Document 2) as a conductive additive, instead of the use of a particulate conductive additive such as acetylene black. The single layer or the stacked layer of graphene having a two-dimensional expansion improves the adhesion between an active material and the conductive additive and the adhesion between conductive additives, leading to an increase in conductivity of an electrode.

Graphene, which has electrically, mechanically, or chemically marvelous characteristics, is a carbon material that is expected to be applied to a variety of fields, such as field-effect transistors and solar batteries. However, it is known that graphene is unlikely to be dispersed. Graphene needs to be dispersed so that graphene can be used as a conductive additive. Non-Patent Document 1 discloses an example of forming graphene in which graphene oxide (GO) is reduced by thiourea. Note that graphene formed by reducing graphene oxide as described above is referred to as RGO (Redused Graphene Oxide).

### REFERENCE

### Patent Document

[Patent Document 1] Japanese Published Patent Application No. 2002-110162
[Patent Document 2] Japanese Published Patent Application No. 2012-64571

### Non-Patent Document

### [Non-Patent Document 1]

Liu Y, et al. Journal of Nanoscience and Nanotechnology Carbon, 2011, 11, 10082

### SUMMARY OF THE INVENTION

### Problems to be Solved by the Invention

Since graphene has a large specific surface area, graphene is difficult to disperse and might be aggregated as described above. When aggregated graphene is used as a conductive additive, graphene has a difficulty in sufficiently functioning as the conductive additive. RGO has many defective structures due to oxidation or reduction and its conductivity is a concern. Therefore, there is a need for a method by which separation between an active material and a conductive additive does not occur even through a reduction treatment.

In view of the above, one object of one embodiment of the present invention is to provide a novel method for manufacturing a positive electrode active material. Another object of one embodiment of the present invention is to provide a novel power storage device. Another object of one embodiment of the present invention is to provide a novel positive electrode slurry. Another object of one embodiment of the present invention is to provide a novel positive electrode.

Note that the description of these objects does not preclude the existence of other objects. One embodiment of the present invention does not have to achieve all these objects. Other objects can be derived from the description of the specification, the drawings, and the claims.

### Means for Solving the Problems

In one embodiment of the present invention, a mixture including an active material, a conductive additive including comprising a graphene compound, a binder, and a dispersion medium is applied to a current collector; a drying treatment is performed on the mixture; a heat treatment is performed on the mixture at a temperature higher than a temperature of the drying treatment; the graphene compound in the mixture is reduced by a chemical reaction using a reducing agent; and a thermal reduction treatment is performed on the mixture at a temperature higher than the temperature of the heat treatment.

In one embodiment of the present invention, a mixture including an active material, a conductive additive including a graphene compound, a binder, and a dispersion medium is applied to a current collector; a drying treatment is performed on the mixture; a heat treatment is performed on the mixture at a temperature higher than a temperature of the drying treatment and for a longer time than a time of the drying treatment; the graphene compound in the mixture is reduced by a chemical reaction using a reducing agent; and a thermal reduction treatment is performed on the mixture at a temperature higher than the temperature of the heat treatment.

In the above structures, the temperature of the drying treatment is higher than or equal to R.T. and lower than or equal to 90° C.

In the above structures, the temperature of the heat treatment is higher than or equal to 120° C. and lower than or equal to 140° C.

In the above structures, the temperature of the thermal reduction treatment is higher than or equal to 120° C. and lower than or equal to 180° C.

In the above structures, the temperature of the heat treatment is higher than or equal to 120° C. and lower than or equal to 140° C., and the temperature of the thermal reduction treatment is higher than or equal to 120° C. and lower than or equal to 180° C.

In the above structures, the graphene compound is a RGO.

### Effect of the Invention

According to one embodiment of the present invention, a novel manufacturing method of a positive electrode can be provided. According to another embodiment of the present invention, a novel power storage device can be provided. According to another embodiment of the present invention, a novel positive electrode slurry can be provided. According to another embodiment of the present invention, a novel positive electrode can be provided.

### BRIEF DESCRIPTION OF THE DRAWINGS

FIG. 1 is a chart describing an example of a method for manufacturing an electrode.

FIG. 2 is a chart describing an example of a method for manufacturing an electrode.

FIG. 3A is a perspective view of a secondary battery, and FIG. 3B is a cross-sectional perspective view thereof, and FIG. 3C is a schematic cross-sectional view in charging.

FIG. 4A is a perspective view of a secondary battery, and FIG. 4B is a cross-sectional perspective view thereof, FIG. 4C is a perspective view of a battery pack including a plurality of secondary batteries, and FIG. 4D is a top view thereof.

FIG. 5A and FIG. 5B are diagrams illustrating an example of a secondary battery.

FIG. 6A and FIG. 6B are diagrams illustrating a laminated secondary battery.

FIG. 7A and FIG. 7B are diagrams each illustrating an example of a secondary battery.

FIG. 8A, FIG. 8B, FIG. 8C, FIG. 8D, and FIG. 8E are perspective views illustrating examples of electronic devices.

FIG. 9 shows charge and discharge curves of Sample manufactured in Example.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

Graphene can be said to be a material which has conductivity and a structure in which hexagons with six carbon atoms are formed in a two-dimensional sheet. Other examples of such a material include a carbon nanotube. In this specification, there is no particular limitation on the number of layers in graphene and any of single-layer graphene, multilayer graphene, thin-layer graphene, few-layer graphene may be used.

Examples of the method for forming graphene include a method of reducing graphene oxide to obtain RGO as described above and a method of physically separating graphite. When graphene oxide is reduced, it is difficult to release all oxygen contained in graphene oxide, and oxygen partly remains on RGO. In the case of forming graphene with the method of physically separating graphene, only a slight amount of oxygen is contained in the obtained graphene. The oxygen content in graphene obtained with the method of physically separating graphite is preferably greater than or equal to 0 atomic % and less than or equal to 4 atomic % or greater than 0 atomic % and less than or equal to 4 atomic %, further preferably greater than or equal to 0 atomic % and less than or equal to 2 atomic % or greater than 0 atomic % and less than or equal to 2 atomic %.

Note that graphene in this specification and the like includes single-layer graphene and multilayer graphene including two to hundred layers. Single-layer graphene refers to a one-atomic-layer thick sheet of carbon molecules having π bonds. Graphene oxide refers to a compound formed by oxidation of such graphene and is a plurality of graphenes in which a distance between a plurality of single-layer graphenes is greater than 0.34 nm and less than or equal to 1.5 nm. In the multilayer graphene, strong interaction is generated between single-layer graphenes, meanwhile, graphene oxide includes a polar functional group such as an epoxy group, a carbonyl group, a carboxyl group, or a hydroxyl group; thus in the graphene oxide, interaction generated between single-layer graphenes is low. Accordingly, a distance between a plurality of single-layer graphenes in the graphene oxide is larger than a distance between a plurality of single-layer graphenes in the multilayer graphene.

### Embodiment 1

In this embodiment, an electrode including graphene as a conductive additive and an electrode including a graphene compound as a conductive additive will be described.

For formation of an electrode, an electrode mixture composition is formed first. The electrode mixture composition includes an active material (hereinafter, a particulate active material is also referred to as an active material particle) and a conductive additive. Note that the electrode mixture composition may include a dispersion medium (also called a solvent), and a binder, and may be in a state of slurry or paste.

Compounds whose basic skeleton is based on graphene capable of being used as a conductive additive are referred to as graphene compounds. Graphene, graphene oxide, and RGO (Reduced Graphene Oxide) are each one kind of graphene compounds.

Graphene is a carbon material having a crystal structure in which hexagonal skeletons of carbon are arranged in plane and has outstanding features in terms of electrical, mechanical, or chemical properties.

A graphene compound has excellent electrical characteristics of high conductivity and excellent physical properties of high flexibility and high mechanical strength. A graphene compound is preferable because the graphene compound enables surface contact having low contact resistance and reduction in electric resistance in some cases. Furthermore, a graphene compound has a planar shape, extremely high conductivity even when being thin in some cases and thus allows a conductive path to be formed in an active material layer efficiently even with a small amount. Hence, a graphene compound is preferably used as the conductive additive, in which case the contact area between the active material and the conductive additive can be increased.

In particular, graphene oxide is preferable because of its high dispersibility in a solvent. In the case in which the graphene oxide is reduced to form graphene (RGO), not entire oxygen or the like contained in the graphene oxide is release but part of oxygen may remain in the graphene, and an alkyl group supported by an ether bond or an ester bond may be included. Furthermore, alcohol that is intercalated into graphene oxide is not entirely removed but may partly remain in the graphene.

A binder may be added to the mixture of graphene oxide and an active material. By the addition of the binder, the active material can be bound to graphene oxide so as to keep a state in which graphene oxide is evenly mixed in the active material.

Here, a reduction treatment is performed on the electrode including graphene oxide. Examples of a method for reducing graphene oxide are reduction with heating (hereinafter referred to as thermal reduction), electrochemical reduction performed by application of a potential at which graphene oxide is reduced to an electrode in an electrolytic solution (hereinafter referred to as electrochemical reduction), and reduction using a chemical reaction caused with a reducing agent (hereinafter referred to as chemical reduction). At least one of chemical reduction and thermal reduction can be performed as the reduction treatment, and it is more preferable to performed both chemical reduction and thermal reduction.

A functional group that is likely to be reduced is different between chemical reduction and thermal reduction. A reducing agent has a great effect of reducing a carbonyl group (C═O) and a carboxy group (—COOH) in graphene oxide by protonation. In contrast, thermal reduction is effective in reducing a hydroxy group (—OH) in graphene oxide by dehydration. Therefore, performing both chemical reduction and thermal reduction can achieve efficient reduction and improve conductivity of reduced graphene oxide.

Furthermore, a thermal reduction treatment is preferably performed after a chemical reduction treatment, in which case the conductivity of the obtained graphene can be further increased.

By the reduction treatment, oxygen contained in the graphene oxide is released, whereby an active material layer including graphene can be formed. Note that oxygen contained in the graphene oxide is not entirely released and some oxygen may remain in the graphene.

On the other hand, the binding force between the active material in the electrode mixture composition and graphene oxide might be decreased due to the chemical reduction treatment. For example, when a binder is dissolved in the solvent used for the chemical reduction treatment, the binding force between the active material and graphene oxide is weakened, and the active material, graphene oxide, or the like is peeled off from a current collector, increasing the possibility of collapse of the electrode in a later step.

Before the chemical reduction treatment, the electrode mixture composition is subjected to heat treatment. The heat treatment can increase the binding force between the active material and graphene oxide in the electrode mixture composition.

For example, the heat treatment is preferably performed under conditions that at least part of the binder is crystallized. When the binder is crystallized, the binder is unlikely to be dissolved in a solvent used for the chemical reduction treatment and the binding force between the active material and graphene oxide can be prevented from being reduced. Thus, the heat treatment is preferably performed at a temperature higher than or equal to a temperature at which the binder is crystallized and lower than or equal to a temperature at which the binder is dissolved.

Further, the reduction rate tends to be decreased when the chemical reduction treatment is performed after the thermal reduction treatment, and thus the conditions for the heat treatment are preferably selected as appropriate so as not to cause thermal reduction. Therefore, in the case where the thermal reduction is performed after the chemical reduction treatment, the heat treatment is preferably performed at a temperature lower than the temperature in the thermal reduction treatment and for a shorter time than the time in the thermal reduction treatment.

### <Manufacturing Method>

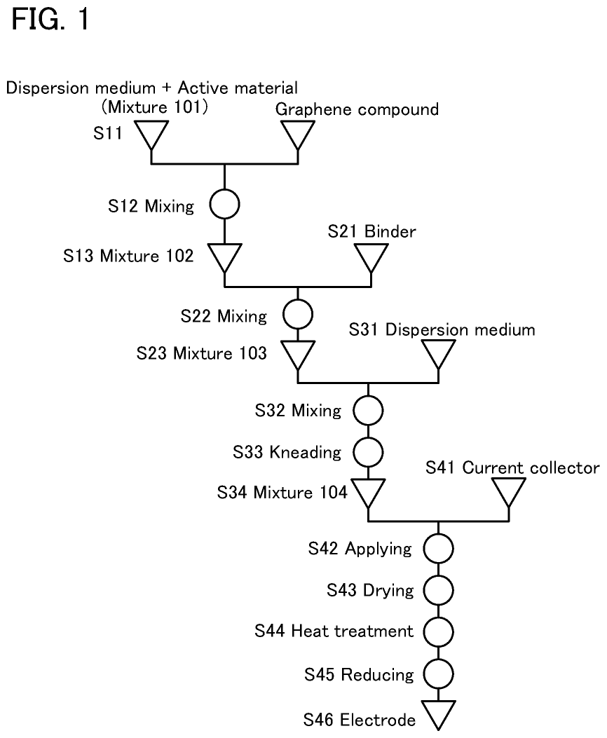

A method for forming the electrode mixture composition and an electrode of one embodiment of the present invention will be described below with reference to FIG. 1. Note that a mixture including the active material and the conductive additive may be referred to as an electrode mixture composition.

First, a mixture 101 including at least a dispersion medium and an active material and a graphene compound serving as a conductive additive are prepared (Step S11 in FIG. 1). The mixture 101 and the graphene compound are mixed (Step S12 in FIG. 1) to form a mixture 102 (Step S13 in FIG. 1). Note that as the graphene compound, one or more of graphene, graphene oxide, and RGO may be used.

In Step S11, the mixed amount of the active material and the graphene compound is important. With the large amount of the active material, the capacity of the positive electrode or the negative electrode to be formed is increased, but the content of the graphene compound serving as the conductive additive is relatively decreased. Excessively small amount of the conductive additive results in reduction of the conductivity and battery characteristics. Thus, the preferred mixed amount of the active material and the graphene compound is that the graphene compound is contained at an amount needed to secure the conductivity and the content of the active material is the maximum.

A polar solvent is preferably used as the dispersion medium. As the polar solvent, N-methyl-2-pyrrolidone (abbreviation: NMP) N,N-dimethylformamide (abbreviation: DMF), dimethylsulfoxide (abbreviation: DMSO) or the like can be used.

Next, the binder is prepared (Step S21 in FIG. 1), and the mixture 102 and the binder are mixed (Step S22 in FIG. 1) to form a mixture 103 (Step S23 in FIG. 1).

The mixed amount of the binder may be determined as appropriate depending on the amounts of the graphene compound and the active material. The binder is mixed while the graphene compound is dispersed to make surface contact with the plurality of particles of the active material, so that the active material and the graphene compound can be bound to each other with the dispersion state kept. Although the binder is not necessarily added depending on the ratios of the active material and the graphene compound, adding the binder can enhance the strength of the electrode.

Examples of the binder are polyvinylidene fluoride (PVDF), polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

Next, a dispersion medium is prepared (Step S31 in FIG. 1) and is added to the mixture 103 and mixed until a predetermined viscosity is obtained (Step S32 in FIG. 1), and then kneading is performed (Step S33 in FIG. 1). Through the above steps, a mixture 104 can be formed (Step S34 in FIG. 1).

Note that in the case where the viscosity of the mixture 103 is about the predetermined viscosity, the mixture 103 may be kneaded, with no addition of the dispersion medium (without S31 and S32), to form the mixture 104. The above-described polar solvent can be used for the dispersion medium in this step. Furthermore, it is preferable to use the same dispersion medium as the dispersion medium prepared in Step S11.

Next, a current collector is prepared (Step S41 in FIG. 1), and the mixture 104, which is the electrode mixture composition formed through Step S11 to Step S34, is applied to one surface or both surfaces of the current collector by an application method such as a roll coating method using an applicator roll or the like, a screen printing method, a doctor blade method, a spin coating method, or a bar coating method, for example (Step S42 in FIG. 1).

The electrode mixture composition applied to the current collector is dried by a method such as ventilation drying or reduced pressure (vacuum) drying (Step S43 in FIG. 1). For example, as the drying treatment, a heat treatment may be performed. There is no particular limitation on the atmosphere of drying (heat treatment).

Here, the drying treatment is preferably performed at a temperature higher than or equal to room temperature (R.T.) and lower than or equal to 120° C., preferably at a relatively low temperature of higher than or equal to room temperature (R.T.) and lower than or equal to 90° C. Note that as for the numerical ranges stepwisely described in this specification, the upper limit or the lower limit in a certain numerical range may be replaced with the upper limit or the lower limit in any of the other numerical ranges stepwisely described in this specification.

In particular, when the drying treatment is performed at a high temperature, binder migration occurs in some cases. Specifically, when the binder in the dispersion medium is moved in the dispersion medium (migration), it is highly probable that the binder is unevenly distributed in the dispersion medium and the strength of the electrode decreases. In addition, the graphene compound and the active material in the dispersion medium are moved in the dispersion medium, whereby the graphene compound and the active material are unevenly distributed in the dispersion medium in some cases. In other words, when a heat treatment is performed rapidly, unevenness is caused in the electrode, so that the active material and the graphene compound are separated from each other in some cases.

Next, a heat treatment is performed at a temperature higher than that of the drying treatment (Step S44 in FIG. 1). There is no particular limitation on the atmosphere of the heat treatment. The heat treatment is preferably performed under reduced pressure (in vacuum).

For example, the heat treatment is preferably performed under conditions that at least part of the binder is crystallized. Thus, the heat treatment is preferably performed at a temperature higher than or equal to a temperature at which the binder is crystallized and lower than or equal to a temperature at which the binder is dissolved.

The conditions of the above heat treatment are preferably selected as appropriate so as not to cause thermal reduction. In the case where thermal reduction is caused, a substituent that can be reduced by chemical reduction might be changed. Accordingly, the rate of reduction by the chemical reduction is reduced in some cases.

Accordingly, for example, the heat treatment is preferably performed at a temperature higher than or equal to 120° C. and lower than or equal to 170° C., further preferably higher than or equal to 120° C. and lower than or equal to 160° C., further preferably higher than or equal to 120° C. and lower than or equal to 140° C.

After the dispersion medium of the electrode mixture composition is evaporated by the drying treatment, the heat treatment is further performed at a temperature at which the binder is crystallized, whereby the binding force between the active material and the graphene oxide in the electrode mixture composition can be strengthened without uneven distribution of the graphene compound and the active material in the electrode.

Therefore, the temperature of the heat treatment is preferably higher than that of the drying treatment (Step S43) in the previous step and lower than that of a thermal reduction treatment (Step S45) in the following step. Preferably, the time of the heat treatment is longer than that of the drying treatment in the previous step and is shorter than that of the thermal reduction treatment in the following step

Thus, the drying treatment and the heat treatment can be performed with the use of hot air at higher than or equal to 40° C. and lower than or equal to 170° C. for longer than or equal to 1 minute and shorter than or equal to 10 hours, preferably longer than or equal to 1 minute and shorter than or equal to 1 hour. Note that by increasing the temperature in a stepwise manner from the drying treatment to the heat treatment, the electrode with no unevenness of the graphene oxide and the active material can be obtained.

Next, a reduction treatment is performed on the electrode mixture composition subjected to heat treatment, on the current collector (Step S45 in FIG. 1). As the reduction method, chemical reduction is preferably used. In addition to the chemical reduction, thermal reduction may be used.

Examples of a reducing agent used for the chemical reduction include organic acid typified by ascorbic acid, hydrogen, sulfur dioxide, sulfurous acid, sodium sulfite, sodium hydrogen sulfite, ammonium sulfite, hydrazine, dimethyl hydrazine, hydroquinone, and phosphorous acid.

In the case where ascorbic acid is used as the reducing agent, the ascorbic acid is dissolved in a solvent first. As the solvent, one of water, NMP, and ethanol, a mixture of one or more of water, NMP, and ethanol, or the like can be used. Then, the current collector and the electrode mixture composition formed in Step S44 are immersed in the solution. This treatment can be performed for longer than or equal to 30 minutes and shorter than or equal to 10 hours, preferably for approximately one hour. Moreover, heating is preferably performed, in which case the chemical reduction time can be shortened. The current collector and the electrode mixture composition can be heated to higher than or equal to room temperature and lower than or equal to 100° C., preferably approximately 60° C., for example.

Heat reduction treatment may be performed after the chemical reduction treatment. The heat reduction treatment is preferably performed under a reduced pressure. A glass tube oven can be used for the heating, for example. A glass tube oven can perform heating under a reduced pressure of approximately 1 kPa.

The optimal heating temperature and heating time are different depending on materials of the conductive additive and the binder to be used. For example, in the case where graphene oxide is used as the conductive additive and PVDF is used as the binder, the heating temperature is preferably a temperature at which the graphene oxide is sufficiently reduced and PVDF is not adversely affected, e.g. crystallization of PVDF. Specifically, the temperature is higher than or equal to 125° C. and lower than or equal to 200° C., preferably higher than or equal to 125° C. and lower than or equal to 180° C.

At a temperature lower than or equal to 100° C., there is a concern that reduction of graphene oxide does not sufficiently proceed. Meanwhile, at a temperature higher than or equal to 250° C., there is concern that the PVDF is adversely affected and the electrode mixture composition is likely to be separated from the current collector.

The heating time is preferably longer than or equal to 1 hour and shorter than or equal to 20 hours. In the case where the heating time is shorter than 1 hour, there is a concern that graphene oxide is not sufficiently reduced. In the case where the heating time is longer than 20 hours, productivity is decreased.

Through the above steps, the positive electrode or the negative electrode including the graphene compound as the conductive additive can be formed (Step S46 in FIG. 1).

As described above, the electrode mixture composition includes, in addition to the active material and the conductive additive, the binder and the dispersion medium in some cases. There is no particular limitation on the order of mixing the dispersion medium, the active material, the conductive additive, and the binder in the case of forming the electrode mixture composition using acetylene black, which is often used as the conductive additive. However, as in one embodiment of the present invention, in the case of using a graphene compound as the conductive additive, especially, a graphene compound with a small content of oxygen, which is obtained by the method in which graphite is physically (mechanically) separated, the graphene compound is aggregated depending on the order of mixing the dispersion medium, the active material, the conductive additive, and the binder, and thus an electrode exhibiting good battery characteristics is difficult to obtain.

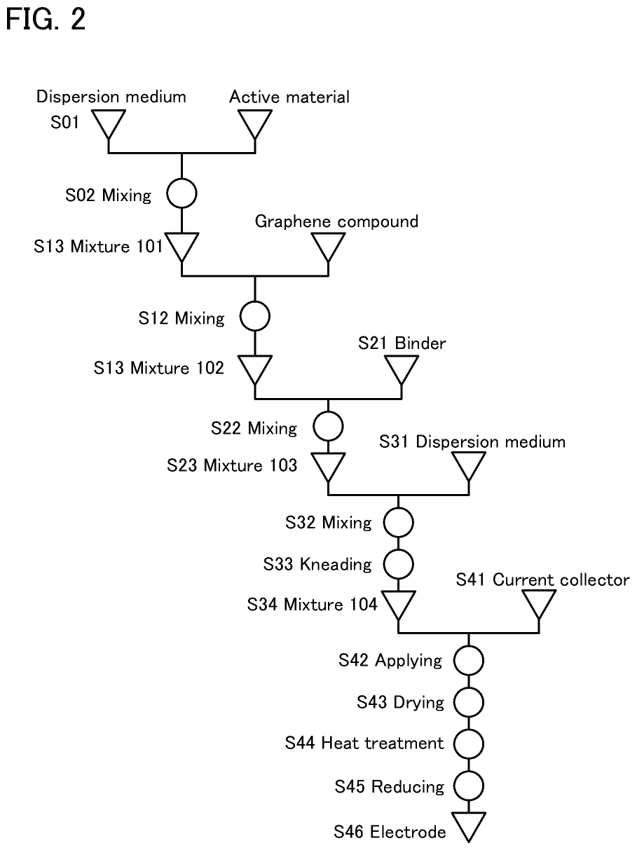

As illustrated in FIG. 2, the mixture 101 may be adjusted by mixing the dispersion medium with the active material (Step S01 and Step S02). Step S01 and Step S02 are preferably performed, in which case the mixture 101 can be adjusted to have an appropriate viscosity or concentration. Note that detailed description of operations in FIG. 2 similar to those in FIG. 1 are omitted, because they are similar to those in FIG. 1.

### <Material>

A manufacturing method and components of an electrode of one embodiment of the present invention will be described here.

### «Active Material»

As the material that can be used for the active material, a material into/from which carrier ions such as lithium ions can be inserted and extracted is used, and a positive electrode active material or a negative electrode active material can be used.

### <Positive Electrode Active Material>

As a material of the positive electrode active material, a compound such as LiFeO₂, LiCoO₂, LiNiO₂, LiMn₂O₄, V₂O₅, Cr₂O₅, or MnO₂ can be used, for example.

Further, lithium-containing complex phosphate having an olivine structure (general formula LiMPO₄ (M is one or more of Fe(II), Mn(II), Co(II), and Ni(II))) can be used. Typical examples of the general formula LiMPO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

In particular, LiFePO₄ is preferable because it meets requirements with balance for the positive electrode active material, such as safety, stability, high capacity density, high potential, and the existence of lithium ions that can be extracted in initial oxidation (charging).

Examples of the lithium-containing composite metal oxide with a layered rock-salt crystal structure include lithium cobalt oxide (LiCoO₂), LiNiO₂, LiMnO₂, Li₂MnO₃, a NiCo-based material (general formula: LiNiₓCo₁₋ₓO₂ (0<x<1)) such as LiNi_{0.8}Co_{0.2}O₂, a NiMn-based material (general formula: LiNiₓMn₁₋ₓO₂ (0<x<1)) such as LiNi_{0.5}Mn_{0.5}O₂, a NiMnCo-based material (also referred to as NMC; general formula: LiNiₓMn_{y}Co_{1-x-y}O₂ (x>0, y>0, x+y<1)) such as LiNi_{1/3}Mn_{1/3}Co_{1/3}O₂. Moreover, Li(Ni_{0.8}Co_{0.15}Al_{0.05})O₂, Li₂MnO₃—LiMO₂ (M=Co, Ni, or Mn), and the like can be given.

In particular, LiCoO₂ is preferable because it has advantages such as high capacity, higher stability in the air than that of LiNiO₂, and higher thermal stability than that of LiNiO₂.

Examples of a lithium-containing composite manganese oxide with a spinel crystal structure include LiMn₂O₄, Li₁₊ₓMn₂₋ₓO₄ (0<x<2), LiMn₂₋ₓAlₓO₄ (0<x<2), and LiMn_{1.5}Ni_{0.5}O₄.

It is preferred that a small amount of lithium nickel oxide (LiNi₁₋ₓMₓO₂ (0<x<1) or LiNi₁₋ₓMₓO₂ (0<x<1) or (M=Co, Al, or the like)) be mixed into a lithium-containing composite manganese oxide with a spinel crystal structure that contains manganese, such as LiMn₂O₄, in which case an advantage such as inhibition of the dissolution of manganese can be obtained.

Further, a lithium-containing complex silicate such as general formula Li₍₂₋ⱼ)MSiO₄ (M is one or more of Fe(II), Mn(II), Co(II), and Ni(II) and 0≤j≤2) can be used. Typical examples of the general formula Li(₂₋ⱼ)MSiO₄ are Li(₂₋ⱼ)FeSiO₄, Li(₂₋ⱼ)CoSiO₄, Li(₂₋ⱼ)MnSiO₄, Li(₂₋ⱼ)FeₖNiₗSiO₄, Li(₂₋ⱼ)FeₖCoₗSiO₄, Li(₂₋ⱼ)FeₖMnₗSiO₄, Li(₂₋ⱼ)NiₖCoₗSiO₄, Li(₂₋ⱼ)NiₖMnₗSiO₄ (k+l≤1, 0<k<1, and 0<l<1), Li(₂₋ⱼ)FeₘNiₙCo_{q}SiO₄, Li(₂₋ⱼ)FeₘNiₙMn_{q}SiO₄, Li(₂₋ⱼ)NiₘCoₙMn_{q}SiO₄ (m+n+q≤1, 0<m<1, 0<n<1, and 0<q<1), and Li(₂₋ⱼ)FeᵣNiₛCoₜMnᵤSiO₄ (r+s+t+u≤1, 0<r<1, 0<s<1, 0<t<1, and 0<u<1).

Still alternatively, a NASICON compound represented by a general formula AₓM₂(XO₄)₃ (A=Li, Na, or Mg, M=Fe, Mn, Ti, V, Nb, or Al, X=S, P, Mo, W, As, or Si) can be used as the positive electrode active material. Examples of the NASICON compound include Fe₂(MnO₄)₃, Fe₂(SO₄)₃, and Li₃Fe₂(PO₄)₃. Further alternatively, a compound represented by a general formula Li₂MPO₄F, Li₂MP₂O₇, or Li₅MO₄ (M=Fe or Mn), a perovskite fluoride such as FeF₃, a metal chalcogenide (a sulfide, a selenide, or a telluride) such as TiS₂ and MoS₂, a lithium-containing composite vanadium oxide with an inverse spinel structure such as LiMVO₄, a vanadium oxide (V₂O₅, V₆O₁₃, LiV₃O₈, and the like), a manganese oxide, or an organic sulfur compound can be used as the positive electrode active material.

In the case where carrier ions are alkali metal ions other than lithium ions or alkaline-earth metal ions, for the positive electrode active material, an alkali metal (e.g., sodium or potassium), an alkaline-earth metal (e.g., calcium, strontium, barium, beryllium, or magnesium) may be used instead of lithium in the lithium-containing materials.

The positive electrode active material can be a particulate active material made of secondary particles having average particle diameter and particle diameter distribution, which is obtained in such a way that source material compounds are mixed at a predetermined ratio and baked and the resulting baked product is crushed, granulated, and classified by an appropriate means.

### <Negative Electrode Active Material>

As the negative electrode active material, for example, an alloy-based material, a carbon-based material, or the like can be used.

For the negative electrode active material, an element that enables charge and discharge reactions by an alloying and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying and a dealloying reaction with lithium and a compound containing the element, for example, may be referred to as an alloy-based material.

In this specification and the like, SiO refers, for example, to silicon monoxide. Note that SiO can alternatively be expressed as SiOx. Here, x preferably has an approximate value of 1. For example, x is preferably 0.2 or more and 1.5 or less, more preferably 0.3 or more and 1.2 or less.

As the carbon-based material, graphite, graphitizing carbon (soft carbon), non-graphitizing carbon (hard carbon), carbon nanotube, graphene, carbon black, and the like may be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it is relatively easy to have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li+) when lithium ions are intercalated into the graphite (while a lithium-graphite intercalation compound is formed). For this reason, a lithium-ion secondary battery can have a high operating voltage. In addition, graphite is preferable because of its advantages such as a relatively high capacity per unit volume, relatively small volume expansion, low cost, and higher level of safety than that of a lithium metal.

Alternatively, for the negative electrode active material, oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a composite nitride of lithium and a transition metal, can be used. For example, Li_{2.6}Co_{0.5}N₃ is preferable because of high charge and discharge capacity (900 mAh/g and 1890 mAh/cm³).

A composite nitride of lithium and a transition metal is preferably used, in which case the negative electrode active material contains lithium ions and thus can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### «Current Collector»

In the case where a positive electrode is formed, a positive electrode current collector is used as the current collector, and in the case where a negative electrode is formed, a negative electrode current collector is used as the current collector.

The positive electrode current collector can be formed using a material that has high conductivity, such as a metal like stainless steel, gold, platinum, aluminum, and titanium, or an alloy thereof. It is preferable that a material used for the positive electrode current collector not dissolve at the potential of the positive electrode. Alternatively, it is possible to use an aluminum alloy to which an element that improves heat resistance, such as silicon, titanium, neodymium, scandium, or molybdenum, is added. Still alternatively, the positive electrode current collector may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The current collector can have any of various shapes including a foil-like shape, a plate-like shape (sheet-like shape), a net-like shape, a punching-metal shape, and an expanded-metal shape. The current collector preferably has a thickness of greater than or equal to 5 μm and less than or equal to 30 μm.

For the negative electrode current collector, a material similar to that of the positive electrode current collector can be used. Note that a material that is not alloyed with carrier ions such as lithium is preferably used for the negative electrode current collector.

### Embodiment 2

In this embodiment, examples of the shape of a secondary battery including the positive electrode active material manufactured by the manufacturing method described in the above embodiment are described. For the materials used for the secondary battery described in this embodiment, the description of the above embodiment can be referred to.

### [Coin-Type Secondary Battery]

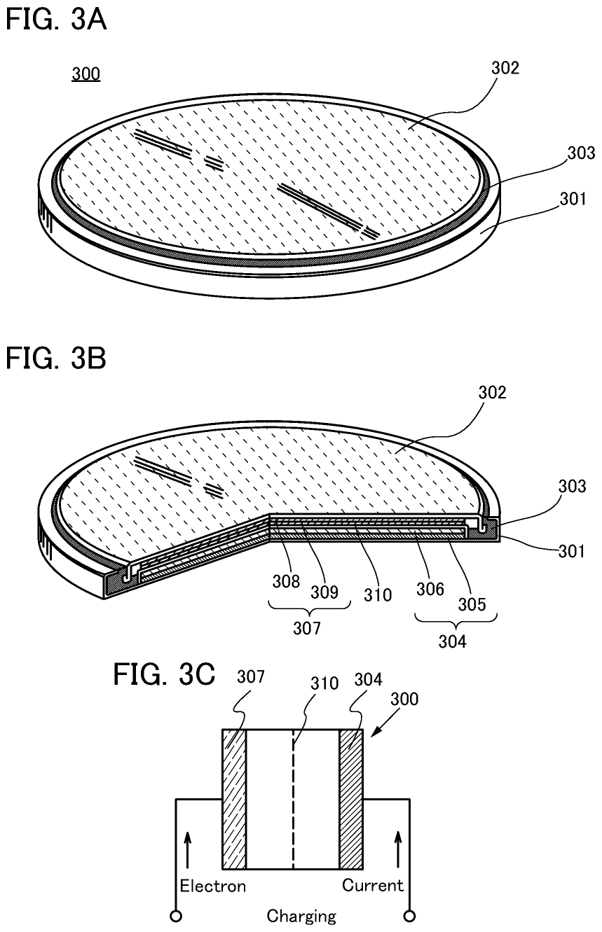

An example of a coin-type secondary battery is described. FIG. 3A is an external view of a coin-type (single-layer flat type) secondary battery, and FIG. 3B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and a separator 310 are immersed in the electrolyte solution; as illustrated in FIG. 3(B), the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

When the active material layer described in the above embodiment is used in the positive electrode 304, the coin-type secondary battery 300 with little deterioration and high safety can be obtained.

### [Separator]

The secondary battery preferably includes a separator. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in high-voltage charge and discharge can be inhibited and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

Here, a current flow in charging a secondary battery is described with reference to FIG. 3C. When a secondary battery using lithium is regarded as a closed circuit, the direction of transfer of lithium ions is the same as the direction of current flow. Note that in a secondary battery using lithium, the anode and the cathode are interchanged in charging and discharging, and the oxidation reaction and the reduction reaction are interchanged; thus, an electrode with a high reaction potential is called the positive electrode and an electrode with a low reaction potential is called the negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of terms such as anode and cathode related to oxidation reaction and reduction reaction might cause confusion because the anode and the cathode are reversed in charging and in discharging. Thus, the terms such as anode and cathode are not used in this specification. If the term such as an anode or a cathode is used, whether it is at the time of charge or discharge is noted and whether it corresponds to a positive electrode or a negative electrode is also noted.

Two terminals illustrated in FIG. 3C are connected to a charger, and the secondary battery 300 is charged. As the charge of the secondary battery 300 proceeds, a potential difference between the electrodes increases.

### [Cylindrical Secondary Battery]

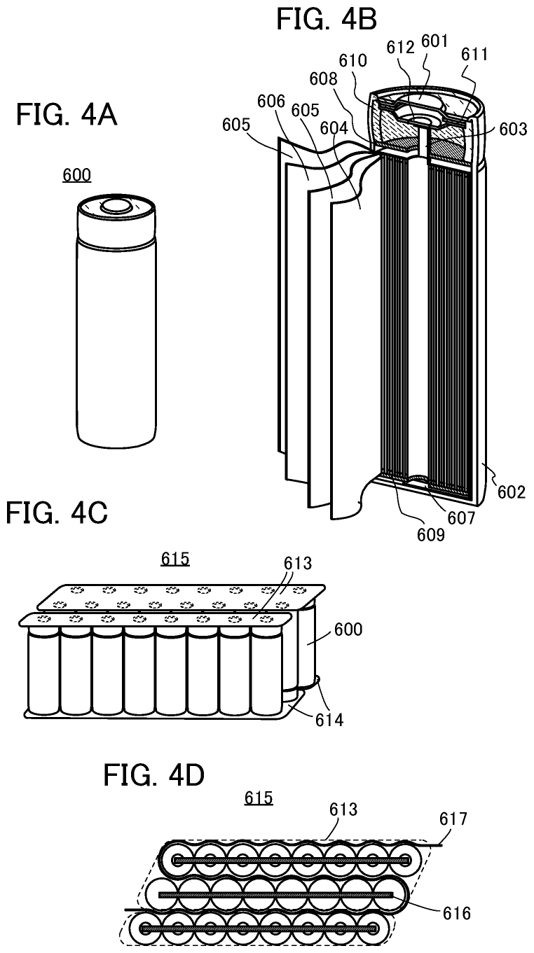

An example of a cylindrical secondary battery is described with reference to FIG. 4A to FIG. 4D. As illustrated in FIG. 4A, the cylindrical secondary battery 600 includes a positive electrode cap (battery lid) 601 on a top surface and a battery can (outer can) 602 on a side surface and a bottom surface. The positive electrode cap and the battery can (outer can) 602 are insulated from each other by a gasket (insulating gasket) 610.

FIG. 4B is a schematic cross-sectional view of a cylindrical secondary battery. Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel or aluminum, for example, in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical secondary battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. The positive electrode terminal 603 and the negative electrode terminal 607 can each be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC (Positive Temperature Coefficient) element 611. The safety valve mechanism 612 cuts off electrical connection between the positive electrode cap 601 and the positive electrode 604 when the internal pressure of the battery increases and exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

As illustrated in FIG. 4C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 4D is a top view of the module 615. The conductive plate 613 is shown by a dotted line for clarity of the drawing. As illustrated in FIG. 4D, the module 615 may include a conductive wire 616 electrically connecting the plurality of secondary batteries 600 with each other. The conductive plate 613 can be provided over and overlap the conductive wire 616. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature.

When the positive electrode active material formed by the manufacturing method described in the above embodiment is used in the positive electrode 604, the cylindrical secondary battery 600 with little deterioration and high safety can be obtained.

### [Structure Examples of Secondary Battery]

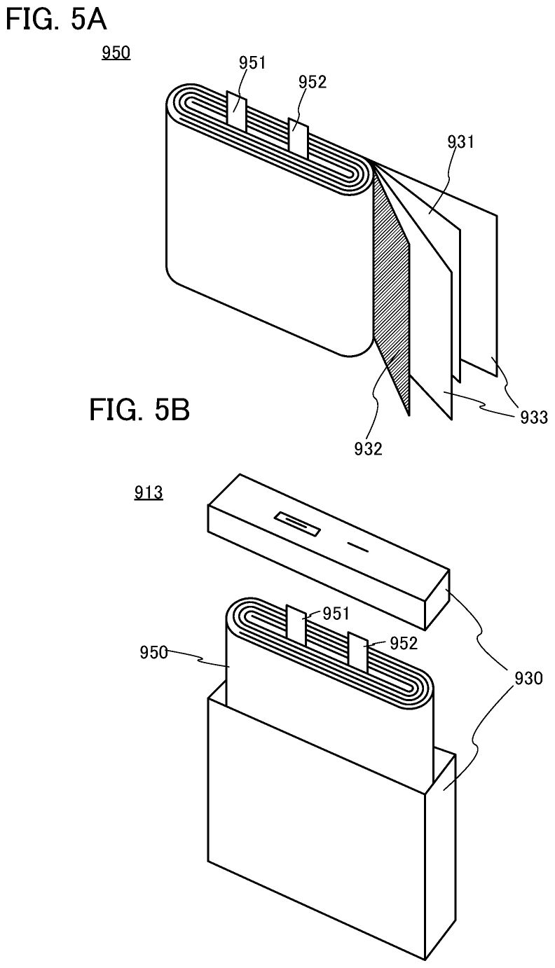

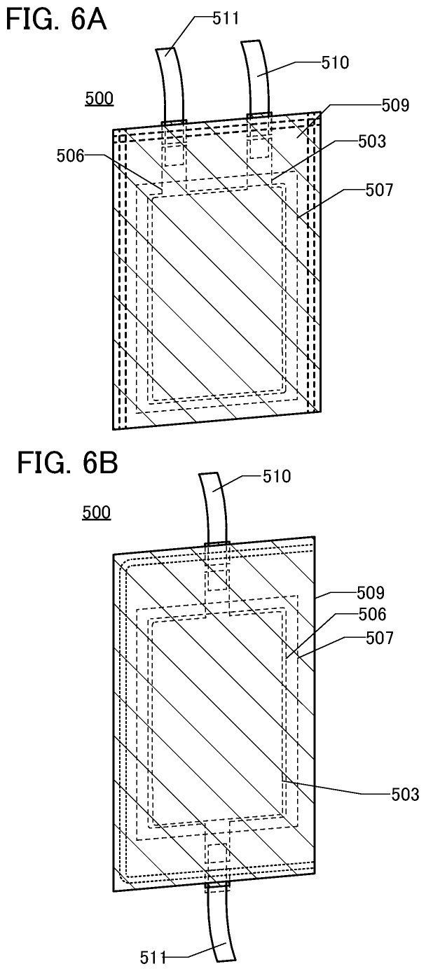

Other structural examples of power storage devices will be described with reference to FIG. 5 and FIG. 6.

FIG. 5A illustrates a structure of a wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks of the negative electrode 931, the positive electrode 932, and the separator 933 may be further overlaid.

The secondary battery 913 illustrated in FIG. 5B includes a wound body 950 provided with the terminal 951 and the terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 5B, the housing 930 that has been divided is illustrated for convenience; however, in reality, the wound body 950 is covered with the housing 930, and the terminal 951 and the terminal 952 extend to the outside of the housing 930. For the housing 930, a metal material (e.g., aluminum) or a resin material can be used.

### [Laminated Secondary Battery>

Next, an example of a laminated secondary battery is described with reference to FIG. 6A and FIG. 6B.

FIG. 6A illustrates an example of an external view of a laminated secondary battery 500. FIG. 6B illustrates another example of an external view of the laminated secondary battery 500.

In FIG. 6A and FIG. 6B, the positive electrode 503, the negative electrode 506, the separator 507, the exterior body 509, a positive electrode lead electrode 510, and a negative electrode lead electrode 511 are included.

The laminated secondary battery 500 includes a wound body or a plurality of positive electrodes 503, separators 507, and negative electrodes 506 that are each strip-shaped.

The wound body includes the negative electrode 506, the positive electrode 503, and the separator 507. The wound body is, like the wound body illustrated in FIG. 5A, obtained by winding a sheet of a stack in which the negative electrode 506 overlaps with the positive electrode 503 with the separator 507 provided therebetween.

The secondary battery may include the plurality of positive electrodes 503, separators 507, and negative electrodes 506 that are each strip-shaped in a space formed by a film serving as the exterior body 509.

A manufacturing method of the secondary battery including the plurality of positive electrodes 503, separators 507, and negative electrodes 506 that are each strip-shaped is described below.

First, the negative electrodes 506, the separators 507, and the positive electrodes 503 are stacked. This embodiment describes an example using five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrodes 506, the separators 507, and the positive electrodes 503 are placed over the exterior body 509.

As the exterior body 509, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The exterior body 509 is folded to interpose the stack therebetween. Then, the outer edges of the exterior body 509 are bonded to each other. The bonding can be performed by thermocompression, for example. In this bonding, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert gas atmosphere. Lastly, the inlet is sealed by bonding. In the above manner, the laminated secondary battery 500 can be manufactured.

When the active material layer described in the above embodiment is used in the positive electrode 503, the secondary battery 500 with little deterioration and high safety can be obtained.

This embodiment can be freely combined with any of the other embodiments.

### Embodiment 3

In this embodiment, a structure of a solid secondary battery will be described. In this specification, not only a secondary battery including only a solid electrolyte but also a secondary battery including a polymer gel electrolyte, a few amount of electrolyte, or a combination thereof is also referred to as a solid battery.

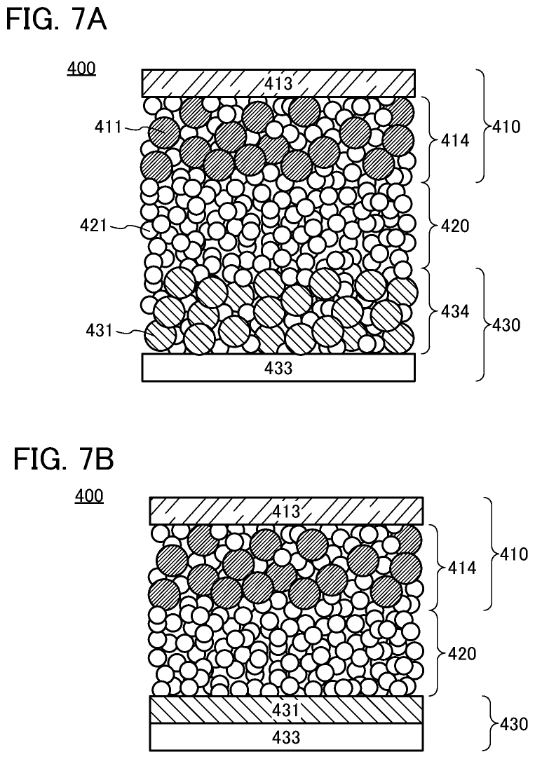

As illustrated in FIG. 7A, a secondary battery 400 that is the solid battery of one embodiment of the present invention includes a positive electrode 410, a solid electrolyte layer 420, and a negative electrode 430. FIG. 7A illustrates a case of using a solid electrolyte. When the solid electrolyte is used, a separator and a spacer are not necessary. Furthermore, the battery can be entirely solidified; therefore, there is no possibility of liquid leakage and thus the safety is dramatically increased.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material described in the above embodiment can be used. The positive electrode active material layer 414 may also include a conductive material and a binder. As the conductive material, a carbon material such as carbon black (e.g., acetylene black (AB)), graphite (black lead) particles, carbon nanotubes (CNT), or fullerene can be used. Alternatively, metal powder or metal fibers of copper, nickel, aluminum, silver, gold, or the like, a conductive ceramic material, or the like can be used. Alternatively, a graphene compound may be used as the conductive material. A graphene compound has excellent electrical characteristics of high conductivity and excellent physical properties of high flexibility and high mechanical strength in some cases. A graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Hence, a graphene compound is preferably used as a conductive additive, in which case the area where the active material and the conductive additive are in contact with each other can be increased. In addition, a graphene compound is preferable because electrical resistance can be reduced in some cases. Here, examples of the graphene compound include graphene, multilayer graphene, multi graphene, graphene oxide, multilayer graphene oxide, multi graphene oxide, graphene oxide that is reduced, multilayer graphene oxide that is reduced, multi graphene oxide that is reduced, and graphene quantum dots. The graphene oxide that is reduced is also referred to as reduced graphene oxide (hereinafter RGO). Note that RGO refers to a compound obtained by reducing graphene oxide (GO), for example. In the case where an active material particle with a small particle diameter, e.g., 1 μm or less, is used, the specific surface area of the active material particle is large and thus more conductive paths for connecting the active material particles are needed. In such a case, a graphene compound that can efficiently form a conductive path even in a small amount is particularly preferably used. In this specification and the like, graphene oxide contains carbon and oxygen, has a sheet-like shape, and includes a functional group, specifically, an epoxy group, a carboxy group, or a hydroxy group. When a plurality of graphene compounds are bonded to each other, a net-like graphene compound sheet (hereinafter referred to as a graphene compound net or a graphene net) can be formed. The graphene net covering the active material can function as a binder for bonding active materials. The amount of binder can thus be reduced, or the binder does not have to be used. This can increase the proportion of the active material in the electrode volume or the electrode weight. That is, the capacity of the secondary battery can be increased.

The solid electrolyte layer 420 includes the solid electrolyte 421. The solid electrolyte layer 420 is positioned between the positive electrode 410 and the negative electrode 430, and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used for the negative electrode 430, it is possible that the negative electrode 430 does not include the solid electrolyte 421 as illustrated in FIG. 7B. The use of metallic lithium for the negative electrode 430 is preferable because the energy density of the secondary battery 400 can be increased. Note that in FIG. 7A and FIG. 7B, the solid electrolyte 421, the positive electrode active material 411, and the negative electrode active material 431 have spherical shapes as ideal particle shapes; however, they actually have various shapes, and thus the shapes are schematically illustrated in the drawings for convenience.

As materials for the solid electrolyte 421 included in the solid electrolyte layer 420 and the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Note that in this specification and the like, a material with a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

Examples of the halide-based solid electrolyte include LiAlCl₄, Li₃InBr₆, LiF, LiCl, LiBr, and LiI. Moreover, a composite material in which pores of porous alumina or porous silica are filled with such a halide-based solid electrolyte can be used as a solid electrolyte.

Alternatively, different kinds of solid electrolytes may be mixed and used.

Alternatively, an electrolyte solution may be mixed to a solid electrolyte.

As the electrolyte solution that is mixed with a solid electrolyte, an electrolyte solution that is highly purified and contains small amounts of dust particles and elements other than the constituent elements of the electrolyte solution (hereinafter also simply referred to as “impurities”) is preferably used. Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution that is mixed with the solid electrolyte. The concentration of a material to be added in the whole solvent is, for example, higher than or equal to 0.1 wt % and lower than or equal to 5 wt %.

As the material mixed with the solid electrolyte, a polymer gel electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

This embodiment can be freely combined with any of the other embodiments.

### Embodiment 4

In this embodiment, examples of electronic devices or a vehicle each using the secondary battery of one embodiment of the present invention will be described.

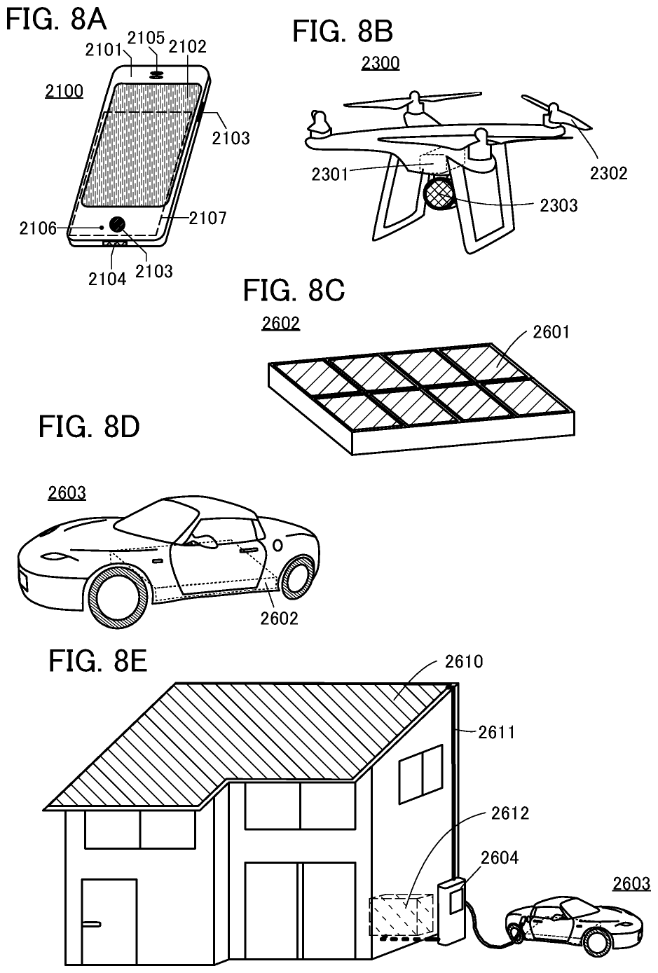

First, FIG. 8A to FIG. 8E show examples of electronic devices each including the secondary battery described in part of Embodiment 2. Examples of electronic devices each including the bendable battery include television devices (also referred to as televisions or television receivers), monitors for computers and the like, digital cameras, digital video cameras, digital photo frames, mobile phones (also referred to as cellular phones or mobile phone devices), portable game machines, portable information terminals, audio reproducing devices, and large game machines such as pachinko machines.

The secondary battery can also be used in moving vehicles, typically automobiles. Examples of the automobiles include next-generation clean energy vehicles such as hybrid vehicles (HEVs), electric vehicles (EVs), and plug-in hybrid vehicles (PHEVs), and the secondary battery can be used as one of the power sources provided for the automobiles. Furthermore, the moving object is not limited to an automobile. Examples of moving vehicles include a train, a monorail train, a ship, and a flying object (a helicopter, an unmanned aircraft (a drone), an airplane, and a rocket), electric vehicles, and electric motorcycles, and the secondary battery of one embodiment of the present invention can be used for the moving vehicles.

The secondary battery of this embodiment may be used in a ground-based charging apparatus provided for a house or a charging station provided in a commerce facility.

FIG. 8A illustrates an example of a mobile phone. A mobile phone 2100 includes a display portion 2102 installed in a housing 2101, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, by mutual communication between the mobile phone 2100 and a headset capable of wireless communication, hands-free calling can be performed.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a body-temperature sensor, a touch sensor, a pressure sensitive sensor, or an acceleration sensor is preferably mounted.

FIG. 8B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention is preferable as a secondary battery mounted on the unmanned aircraft 2300 because it has a high level of safety and thus can be used safely for a long time over a long period.

Furthermore, as illustrated in FIG. 8C, a secondary battery 2602 including a plurality of secondary batteries 2601 of one embodiment of the present invention may be mounted on a hybrid electric vehicle (HEV), an electric vehicle (EV), a plug-in hybrid electric vehicle (PHEV), or another electronic device.

FIG. 8D illustrates an example of a vehicle including the secondary battery 2602. A vehicle 2603 is an electric vehicle that runs using an electric motor as a power source. Alternatively, the vehicle 2603 is a hybrid electric vehicle that can appropriately select an electric motor or an engine as a power source.

The lithium ion battery is installed in an automobile after passing through tests such as a performance test, a reliability test, and an abuse test. In particular, a reliability test is conducted to confirm whether or not battery breakage, an electrical connection error, or the like is caused by a random wave of vibration of a running vehicle or a driving system.

For example, in dropping and collision of a lithium-ion battery, an internal structure of the battery moves downward and a separator between a positive electrode current collector and a negative electrode plate is damaged, leading to short circuiting in charging in some cases. Thus, with use of the secondary battery with high electrode strength of one embodiment of the present invention, a lithium ion battery that can withstand such a reliability test can be provided.

The vehicle 2603 using an electric motor includes a plurality of ECUs (Electronic Control Units) and performs engine control by the ECUs. The ECU includes a microcomputer. The ECU is connected to a CAN (Controller Area Network) provided in the electric vehicle. The CAN is a type of a serial communication standard used as an in-vehicle LAN. The secondary battery of one embodiment of the present invention can be used to function as a power source of ECU and a vehicle with a high level of safety and a long cruising range can be achieved.

The secondary battery not only drives the electric motor (not illustrated) but also can supply electric power to a light-emitting device such as a headlight or a room light. Furthermore, the secondary battery can supply electric power to a display device and a semiconductor device included in the vehicle 2603, such as a speedometer, a tachometer, and a navigation system.

In the vehicle 2603, the secondary batteries included in the secondary battery 2602 can be charged by being supplied with electric power from external charging equipment by a plug-in system, a contactless power feeding system, or the like.

FIG. 8E illustrates a state in which the vehicle 2603 is supplied with electric power from ground-based charging equipment 2604 through a cable. In charging, a given method such as CHAdeMO (registered trademark) or Combined Charging System may be employed as a charging method, the standard of a connector, or the like as appropriate. For example, with a plug-in technique, the secondary battery 2602 incorporated in the vehicle 2603 can be charged by being supplied with electric power from the outside. Charging can be performed by converting AC power into DC power through a converter such as an ACDC converter. The charging equipment 2604 may be provided for a house as illustrated in FIG. 8E, or may be a charging station provided in a commercial facility.

Although not illustrated, the vehicle can include a power receiving device so as to be charged by being supplied with power from an above-ground power transmitting device in a contactless manner. In the case of the contactless power feeding system, by fitting a power transmitting device in a road or an exterior wall, charging can be performed not only when the vehicle is stopped but also when is running. In addition, this contactless power feeding system may be utilized to transmit and receive power between vehicles. Furthermore, a solar cell may be provided in the exterior of the vehicle to charge the secondary battery when the vehicle stops or moves. To supply power in such a contactless manner, an electromagnetic induction method or a magnetic resonance method can be used.

The house illustrated in FIG. 8E includes a power storage system 2612 including the secondary battery of one embodiment of the present invention and a solar panel 2610. The power storage system 2612 is electrically connected to the solar panel 2610 through a wiring 2611 or the like. The power storage system 2612 may be electrically connected to the ground-based charging equipment 2604. The power storage system 2612 can be charged with electric power generated by the solar panel 2610. The secondary battery 2602 included in the vehicle 2603 can be charged with the electric power stored in the power storage system 2612 through the charging equipment 2604.

The electric power stored in the power storage system 2612 can also be supplied to other electronic devices in the house. Thus, with the use of the power storage system 2612 of one embodiment of the present invention as an uninterruptible power source, electronic devices can be used even when electric power cannot be supplied from a commercial power source due to power failure or the like.

This embodiment can be implemented in appropriate combination with any of the other embodiments.

### EXAMPLE

In this example, a secondary battery (Sample 1A) including a positive electrode including reduced graphene oxide as a conductive material was manufactured and the characteristics thereof were evaluated.

### <Manufacture of Secondary Battery>

For evaluation, a CR2032 type coin secondary battery (a diameter of 20 mm, a height of 3.2 mm) was manufactured.

A commercially-obtained LCO (C-10N produced by NIPPON CHEMICAL INDUSTRIAL CO., LTD.) was used for a positive electrode active material of the secondary battery. As a conductive material, graphene oxide (produced by NiSiNa materials Co., Ltd., a Modified Hummers method was employed in an oxidation step) was used. This is reduced in a later step. As a binder, PVDF (TA5130 produced by Solvay) was used. The positive electrode active material, the conductive material, and the binder were mixed at a ratio of 95:3:2 (wt %) to form slurry. NMP was used as a solvent. The slurry was applied on a current collector and dried. Aluminum foil was used for the current collector.

Next, a drying treatment was performed. The drying treatment was performed in such a manner that heat treatment was performed in a ventilation drying furnace at a temperature of 50° C. for one hour, and then, the setting temperature was increased to 80° C. and a heat treatment is performed at 80° C. for 30 minutes.

Next, a heat treatment was performed. The heat treatment was performed under vacuum at a temperature of 130° C. for 10 hours.

Next, the graphene oxide in the positive electrode active material layer was reduced.

First, chemical reduction was performed. As a reducing agent for chemical reduction, L-ascorbic acid was used. As a solvent, 0.078 mol/L of an L-ascorbic acid solution was formed with water and NMP at a volume ratio of 1:9. The electrode coated with a positive electrode active material layer was immersed in the ascorbic acid solution and reacted at 60° C. for one hour.

Next, thermal reduction was performed at the heating temperature of 170° C. for 10 hours as the heating time.

After the reducing treatment, application of linear pressure at 210 kN/m was performed and then pressing at 1467 kN/m was further performed to form the positive electrode.

A lithium metal was used for a counter electrode.

As an electrolyte included in an electrolytic solution, 1 mol/L lithium hexafluorophosphate (LiPF₆) was used. As the electrolytic solution, a solution in which ethylene carbonate (EC) and diethyl carbonate (DEC) were mixed at a volume ratio of EC:DEC=3:7 and vinylene carbonate (VC) was added as an additive at 2 wt % was used.

As a separator, 25-μm-thick polypropylene was used.

A positive electrode can and a negative electrode can that were formed of stainless steel (SUS) were used.

### <Battery Characteristics and Cycle Performance>

Next, a charge and discharge test was performed on Sample 1A. In the measurement, the CCCV charge (0.5 C, 4.2 V, a termination current of 0.05 C) and the CC discharge (0.5 C, a termination voltage of 2.5 V) were performed at 25° C. Note that 1 C was set to 137 mA/g in this example and the like.

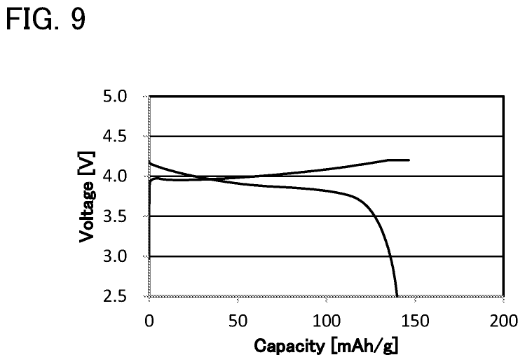

FIG. 9 shows charge and discharge curves of Sample 1A. In Sample 1A, charge and discharge can be performed sufficiently. Sample 1A has a high strength of the positive electrode active material layer.

The secondary battery using graphene oxide as the conductive material is excellent in terms of the strength of the positive electrode active material layer, the discharge performance, or the like.

### REFERENCE NUMERALS

101 mixture, 102 mixture, 103 mixture, 104 mixture, 300 secondary battery, 301 positive electrode can, 302 negative electrode can, 303 gasket, 304 positive electrode, 305 positive electrode current collector, 306 positive electrode active material layer, 307 negative electrode, 308 negative electrode current collector, 309 negative electrode active material layer, 310 separator, 400 secondary battery, 410 positive electrode, 411 positive electrode active material, 413 positive electrode current collector, 414 positive electrode active material layer, 420 solid electrolyte layer, 421 solid electrolyte, 430 negative electrode, 431 negative electrode active material, 433 negative electrode current collector, 434 negative electrode active material layer, 500 secondary battery, 503 positive electrode, 506 negative electrode, 507 separator, 508 electrolyte, 509 exterior body, 510 positive electrode lead electrode, 511 negative electrode lead electrode, 520 solid electrolyte layer, 600 secondary battery, 601 positive electrode cap, 602 battery can, 603 positive electrode terminal, 604 positive electrode, 605 separator, 606 negative electrode, 607 negative electrode terminal, 608 insulating plate, 609 insulating plate, 611 PTC element, 612 safety valve mechanism, 613 conductive plate, 614 conductive plate, 615 module, 616 conducting wire, 617 temperature control device, 904 positive electrode active material, 913 secondary battery, 930 housing, 931 negative electrode, 932 positive electrode, 933 separator, 950 wound body, 951 terminal, 952 terminal, 2100 mobile phone, 2101 housing, 2102 display portion, 2103 operation button, 2104 external connection port, 2105 speaker, 2106 microphone, 2107 secondary battery, 2300 unmanned aircraft, 2301 secondary battery, 2302 rotor, 2303 camera, 2601 secondary battery, 2602 secondary battery, 2603 vehicle, 2604 charging equipment, 2610 solar panel, 2611 wiring, 2612 power storage system

1. A method for manufacturing an electrode, comprising:
applying, to a current collector, a mixture comprising an active material, a conductive additive comprising a graphene compound, a binder, and a dispersion medium;
performing a drying treatment on the mixture;
performing a heat treatment on the mixture at a temperature higher than a temperature of the drying treatment;
reducing the graphene compound in the mixture by a chemical reaction using a reducing agent; and
performing a thermal reduction treatment on the mixture at a temperature higher than the temperature of the heat treatment.

2. A method for manufacturing an electrode, comprising:
applying, to a current collector, a mixture comprising an active material, a conductive additive comprising a graphene compound, a binder, and a dispersion medium;
performing a drying treatment on the mixture;
performing a heat treatment on the mixture at a temperature higher than a temperature of the drying treatment and for a longer time than a time of the drying treatment;
reducing the graphene compound in the mixture by a chemical reaction using a reducing agent; and
performing a thermal reduction treatment on the mixture at a temperature higher than the temperature of the heat treatment.

3. The method for manufacturing an electrode according to claim 1, wherein the temperature of the drying treatment is higher than or equal to R.T. and lower than or equal to 90° C.

4. The method for manufacturing an electrode according to claim 1, wherein the temperature of the heat treatment is higher than or equal to 120° C. and lower than or equal to 140° C.

5. The method for manufacturing an electrode according to claim 1, wherein the temperature of the thermal reduction treatment is higher than or equal to 120° C. and lower than or equal to 180° C.

6. The method for manufacturing an electrode according to claim 1,
wherein the temperature of the heat treatment is higher than or equal to 120° C. and lower than or equal to 140° C., and
wherein the temperature of the thermal reduction treatment is higher than or equal to 120° C. and lower than or equal to 180° C.

7. The method for manufacturing an electrode according to claim 1, wherein the graphene compound is a RGO.

8. The method for manufacturing an electrode according to claim 2, wherein the temperature of the drying treatment is higher than or equal to R.T. and lower than or equal to 90° C.

9. The method for manufacturing an electrode according to claim 2, wherein the temperature of the heat treatment is higher than or equal to 120° C. and lower than or equal to 140° C.

10. The method for manufacturing an electrode according to claim 2, wherein the temperature of the thermal reduction treatment is higher than or equal to 120° C. and lower than or equal to 180° C.

11. The method for manufacturing an electrode according to claim 2,
wherein the temperature of the heat treatment is higher than or equal to 120° C. and lower than or equal to 140° C., and
wherein the temperature of the thermal reduction treatment is higher than or equal to 120° C. and lower than or equal to 180° C.

12. The method for manufacturing an electrode according to claim 2, wherein the graphene compound is a RGO.
